(19) United States
(12) Patent Application Publication
(10) Pub. No.: US 2014/0232032 A1
(43) Pub. Date: Aug. 21, 2014

(54) LITHOGRAPHY ORIGINAL CHECKING DEVICE, LITHOGRAPHY ORIGINAL CHECKING METHOD, AND PATTERN DATA CREATING METHOD

(71) Applicant: KABUSHIKI KAISHA TOSHIBA, Tokyo (JP)

(72) Inventors: Ryoji Yoshikawa, Yokohama-Shi (JP); Daisuke Kawamura, Yokohama-Shi (JP); Seiji Morita, Tokyo (JP); Tatsuhiko Higashiki, Fujisawa-Shi (JP); Takashi Hirano, Kawasaki-Shi (JP)

(73) Assignee: KABUSHIKI KAISHA TOSHIBA, Tokyo (JP)

(21) Appl. No.: 14/018,013

(22) Filed: Sep. 4, 2013

(30) Foreign Application Priority Data
Feb. 21, 2013 (JP) 2013-032304

(51) Int. Cl. G01N 21/956; G01N 1/28

(52) U.S. Cl. CPC G01N 21/956; G01N 1/2806
USPC 264/40.1; 356/36

(57) ABSTRACT

In one embodiment, a lithography original checking method includes applying resin onto a first lithography original having a first concavo-convex pattern, hardening the resin, releasing the hardened resin from the first lithography original and producing a second lithography original having a second concavo-convex pattern corresponding to the first concavo-convex pattern, enlarging the second lithography original, detecting a defect on the enlarged second lithography original, and calculating a position of a defect on the first lithography original based on the position of the detected defect.

### CROSS REFERENCE TO RELATED APPLICATION

This application is based upon and claims benefit of priority from the Japanese Patent Application No. 2013-32304, filed on Feb. 21, 2013, the entire contents of which are incorporated herein by reference.

### FIELD

Embodiments described herein relate generally to a lithography original checking method, a lithography original checking device, and a pattern data creating method.

### BACKGROUND

There is known an optical nanoimprint method as a technique for forming a fine pattern at low cost. This is a method for transferring a pattern by pressing a concavo-convex template corresponding to the pattern to be formed on a substrate onto a photocrosslinkable organic material layer applied on the substrate surface, irradiating a light thereon to harden the organic material layer, and releasing the template from the organic material layer. When a defect is present on the template surface, the defect is also transferred onto the substrate surface. Thus, a template defect check is performed.

In a conventional template defect check, a light source is scanned on a template pattern surface by use of an optical defect checking device comprising a short-wavelength laser (such as fixed SHG laser having a wavelength of 193 nm), an objective lens having a high numerical aperture, and a polarization element optical system for detecting a minute defect, thereby detecting a defect. However, a detectable defect size is limited to up to 20 nm due to an optical resolution limit. Therefore, a defect smaller than the limit cannot be detected.

### BRIEF DESCRIPTION OF THE DRAWINGS

FIG. 1 is a diagram illustrating an exemplary layout of a lithography original to be checked;

FIG. 2 is a cross-section view for explaining a template producing method according to a first embodiment;

FIG. 3 is a cross-section view subsequent to FIG. 2;

FIG. 4 is a cross-section view subsequent to FIG. 3;

FIG. 5 is a diagram illustrating a copy template enlarging processing;

FIGS. 6A to 6C are diagrams illustrating exemplary enlarged defects;

FIG. 7 is a block diagram of a checking device according to the first embodiment;

FIG. 8 is a flowchart for explaining a checking method according to the first embodiment;

FIG. 9 is a diagram illustrating an exemplary enlarged copy template;

FIG. 10 is a block diagram of a checking device according to a second embodiment;

FIGS. 11A and 11B are diagrams illustrating exemplary variation rules; and

FIG. 12 is a diagram illustrating an exemplary coordinate conversion rule.

### DETAILED DESCRIPTION

In one embodiment, a lithography original checking method includes applying resin onto a first lithography original having a first concavo-convex pattern, hardening the resin, releasing the hardened resin from the first lithography original and producing a second lithography original having a second concavo-convex pattern corresponding to the first concavo-convex pattern, enlarging the second lithography original, detecting a defect on the enlarged second lithography original, and calculating a position of a defect on the first lithography original based on the position of the detected defect.

Embodiments will now be explained with reference to the accompanying drawings.

### First Embodiment

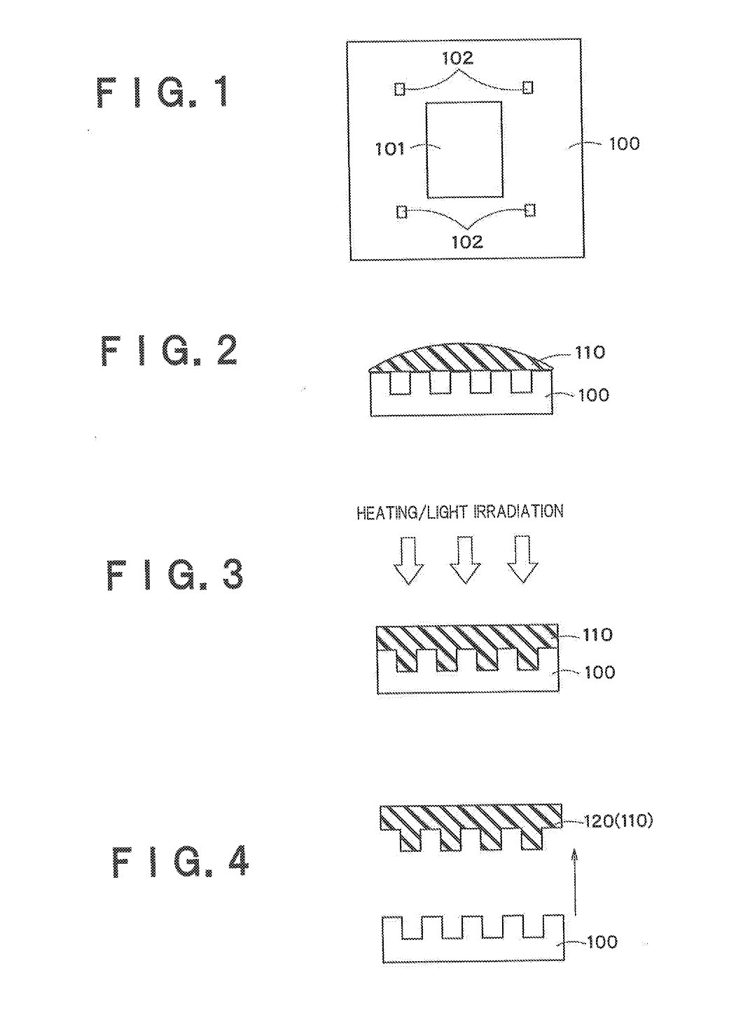

FIG. 1 illustrates an exemplary layout of a lithography original (first lithography original) to be checked. A lithography original (original plate) 100 comprises a main pattern 101 and a plurality of alignment marks 102. The alignment marks 102 may be an exclusively arranged pattern, or a device pattern contained in the main pattern 101. For example, the alignment marks 102 are arranged at the four corners of the lithography original 100.

The lithography original 100 is a template to be used for an imprint processing, or a photomask to be used for a lithography processing, for example. An explanation will be made in the present embodiment assuming that the lithography original 100 to be checked is a template to be used for an imprint processing (which will be called master template below).

As illustrated in FIG. 2, the master template 100 having a fine concavo-convex pattern is prepared. The master template 100 is formed with a concavo-convex pattern (the main pattern 101 and the alignment marks 102) on one surface of a complete transparent quartz substrate by plasma etching, for example.

Subsequently, liquid resin 110 is applied on the pattern surface of the master template 100. The liquid resin 110 is filled in the concavo-convex pattern of the master template 100 due to a capillary phenomenon. The liquid resin 110 used herein contains a pattern transfer component, a pattern retention component and a stretch component. Each component will be described later.

Then, as illustrated in FIG. 3, the liquid resin 110 is filled in the concavo-convex pattern of the master template 100, and then the liquid resin 110 is subjected to light irradiation or heating. Thereby, the liquid resin 110 is hardened. Ultraviolet rays are irradiated for light irradiation.

Then, as illustrated in FIG. 4, the hardened liquid resin 110 is released from the master template 100. Thereby, a copy template (second lithography original) 120 made of the hardened liquid resin 110 is obtained. Since the liquid resin 110 contains a pattern transfer component, the minute concavo-convex pattern of the master template 100 is transferred onto the copy template 120. The pattern transfer component is liquid silicon resin, for example, and may use silicon polymer, silsesquioxane or the like.

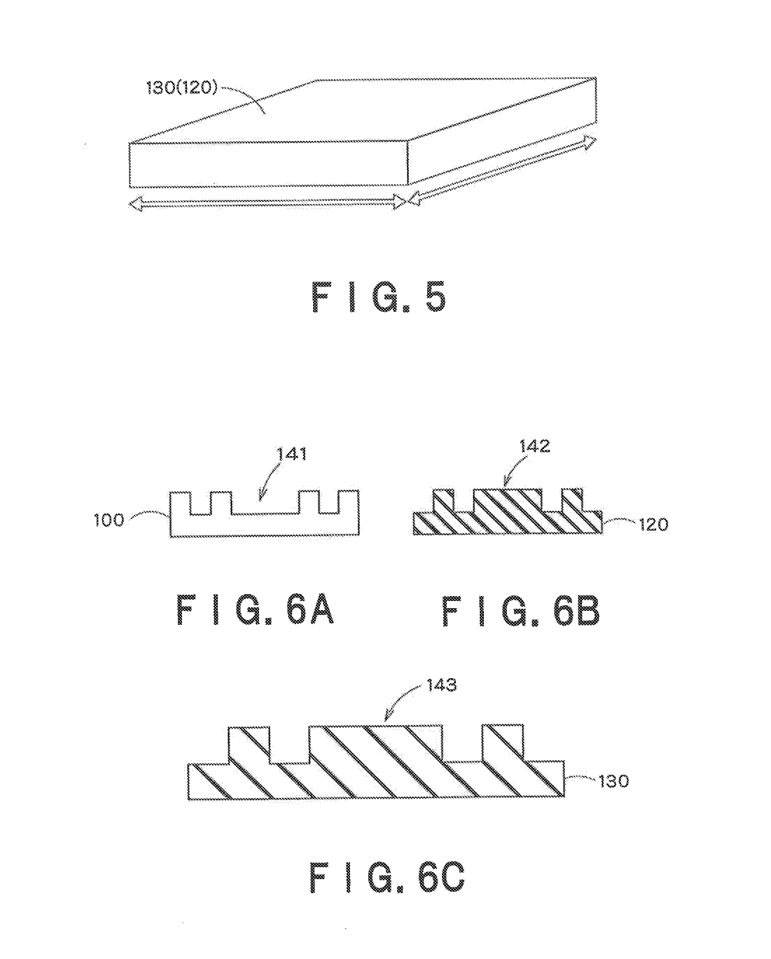

Then, as illustrated in FIG. 5, the copy template 120 is heated and stretched. The copy template 120 is heated as far as it is softened and the concavo-convex pattern of the copy template 120 is not deformed. The concavo-convex pattern is omitted from FIG. 5.

The material (the liquid resin 110) of the copy template 120 contains a stretch component, and thus it is stretched and enlarged. Thereby, an enlarged copy template 130 is obtained. Further, since the material (the liquid resin 110) of the copy template 120 contains a pattern retention component, the concavo-convex pattern is not deformed and is kept even if the copy template 120 is heated and stretched. For example, the copy template 120 is enlarged by 1.5 times or more thereby to obtain the enlarged copy template 130.

The stretch component may use thermoplastic resin such as PMMA (polymethylmethacrylate), PE (polyethylene), PP (polypropylene), PVA (polyvinyl alcohol), PA (polyamide) or POM (polyoxymethylene).

The pattern retention component may use thermoplastic resin such as COP (cycloolefin polymer), PC (polycarbonate), PS (polystyrene), PET (polyethylene terephthalate) AS (acrylonitrile styrene) or ABS (acrylonitrile butadiene styrene).

The copy template 120 may be stretched in one direction, may be orthogonally stretched in two directions (see FIG. 5), or may be stretched in three or more directions. When it is stretched in multiple directions, it may be stretched in multiple directions at the same time, or may be sequentially stretched by one direction. The copy template 120 may be stretched in all directions by being rotated while heated.

There will be assumed that a defect 141 as illustrated in FIG. 6A is present on the concavo-convex pattern of the master template 100. The defect 141 is such that a desired line-and-space pattern is not obtained due to a lacking line part. The defect 141 is transferred as a defect 142 onto the concavo-convex pattern of the copy template 120 as illustrated in FIG. 6B. Then, the copy template 120 is stretched and enlarged so that an enlarged defect 143 appears on the concavo-convex pattern of the enlarged copy template 130, as shown in FIG. 6C.

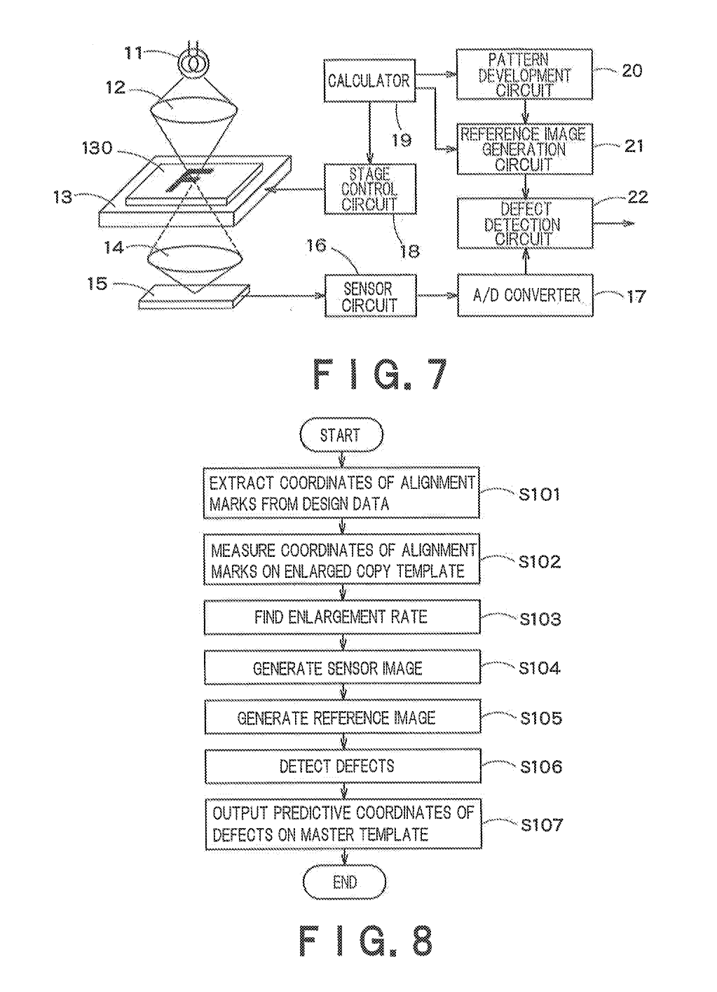

Then, a presence of a defect on the master template 100 is detected by use of a checking device illustrated in FIG. 7.

The checking device comprises an imaging unit having a light source 11, a condensing lens 12, an XV stage 13 for mounting the enlarged copy template 130 thereon, an objective lens 14, and an image sensor 15, a sensor circuit 16, an A/D converter 17, a stage control circuit 18, a calculator 19, a pattern development circuit 20, a reference image generation circuit 21, and a defect detection circuit 22. The imaging unit shoots the pattern of the enlarged copy template 130 thereby to generate a shot image.

The light source 11 is a mercury lamp, argon laser or the like.

The XY stage 13 is configured such that the enlarged copy template 130 is movable in the horizontally biaxial direction (the XY direction). The operation of the XY stage 13 is controlled by the stage control circuit 18.

The image sensor 15 is a CCD sensor in which CCDs (Charge Coupled Device) are arranged in one dimension or two dimensions. A pattern image of the enlarged copy template 130 is enlarged by several hundred times to be formed on the image sensor 15 by the optical system such as the condensing lens 12 or the objective lens 14.

Even when a light receiving area of the image sensor 15 is small, the enlarged copy template 130 is relatively moved in the X direction and in the Y direction relative to the image sensor 15 so that the entire pattern image of the enlarged copy template 130 can be shot. The image sensor 15 outputs the pattern image of the enlarged copy template 130 to the sensor circuit 16.

FIG. 7 illustrates an example using a transmitted light, but a reflected light or a mixture of transmitted light and reflected light may be used depending on the property of the enlarged copy template 130.

The sensor circuit 16 outputs an optical image (sensor image) according to the pattern image output from the image sensor 15. A pixel size of the sensor image is 50 nm×50 nm, for example.

The A/D converter 17 A/D converts the sensor image and outputs the converted image to the defect detection circuit 22.

The pattern development circuit 20 receives design data of the master template 100 from the calculator 19, and develops the design data into pixel-based multivalued tone data having a resolution equivalent to the image sensor. For example, when the sensor image is binary, the pattern development circuit 20 develops the design data into binary tone data.

The reference image generation circuit 21 performs a filter processing or the like on the tone data developed by the pattern development circuit 20, thereby to generate a reference image to be compared with the sensor image. Optical properties, and a change in shape due to an etching process for forming a concavo-convex pattern on the master template are considered for the filter processing. The pixel size of the reference image is the same as the pixel size of the sensor image.

According to the present embodiment, the reference image is generated by use of the tone data output from the pattern development circuit 20, but the reference image according to the design data may be previously stored in a storage unit (not shown) and may be read from the storage unit, or may be input from an input unit (not shown).

The defect detection circuit 22 generates a differential image (mismatched portion's image) between the sensor image output from the A/D converter 17 and the reference image generated by the reference image generation circuit 21, and determines a presence of a pattern defect based on the differential image. The defect detection circuit 22 calculates and outputs a defect coordinate on the master template 100.

A checking method using the checking device will be described below with reference to the flowchart illustrated in FIG. 8.

(Step S101)

The calculator 19 extracts coordinates of the alignment marks 102 from the design data of the master template 100.

(Step S102)

The enlarged copy template 130 is placed on the XY stage 13 and the coordinates of the alignment marks on the enlarged copy template 130 are measured.

(Step S103)

The coordinates of the alignment marks 102 on the master template 100 and the coordinates of the alignment marks on the enlarged copy template 130 are used to find an enlargement rate of the enlarged copy template 130, A rotation angle and the like may be found, not only the enlargement rate.

(Step S104)

The enlarged copy template 103 is shot thereby to generate a sensor image.

(Step S105)

A reference image is generated from the design data of the master template 100.

(Step S106)

A differential image between the sensor image and the reference image is generated and a defect is detected from the differential image.

(Step S107)

An image and coordinate of the defect detected in step S107 are output. The defect coordinates include the coordinates of the enlarged defects on the enlarged copy template 130 and predictive coordinates of the defects on the master template 100. The predictive coordinates of the defects on the master template 100 can be calculated based on the coordinates of the enlarged defects on the enlarged copy template 130, the enlargement rate found in step S103, and the like.

In this way, the defect coordinates on the master template 100 are output so that defect review can be performed by SEM or the defects on the master template 100 can be corrected by use of an electron beam correcting device.

The predictive coordinates of the defects on the master template 100 may be calculated by an external device not the defect detection circuit 22.

For example, when a defect size on the concavo-convex pattern of the master template 100 is as minute as 20 nm or less, the defect is so difficult to shoot. However, an enlarged defect appearing due to the enlargement of the copy template 120 can be shot and expressed in a sensor image, and thus it can be detected by comparison with the reference image.

As described above, according to the present embodiment, the copy template in which the concavo-convex pattern of the master template is copied is enlarged and the enlarged copy template is checked so that a presence of a defect on the master template and the position of the defect can be detected,

The alignment marks 102 are arranged at the four corners of the lithography original 100 according to the embodiment, but the arrangement positions of the alignment marks 102 are not limited thereto. For example, the alignment marks 102 may be arranged at the five positions including the four corners and the center of the lithography original 100.

There has been described, according to the embodiment, a data comparison type defect check in which the sensor image shooting the enlarged copy template 130 and the reference image obtained by developing the design data of the master template 100 are compared thereby to detect a mismatched portion as a defect, but, when the same dies are arranged in a region to be checked, a die comparison type defect check in which the dies are compared with each other thereby to detect a mismatched portion as a defect may be performed.

The copy template 120 is enlarged by heating and stretching according to the embodiment, but the copy template 120 may be enlarged by immersing in an organic solvent and absorbing the organic solvent to expand. Alternatively, a foaming component such as azo compound is contained in the liquid resin 110 and foaming is caused in the copy template 120, and thus the copy template 120 may be expanded and enlarged.

### Second Embodiment

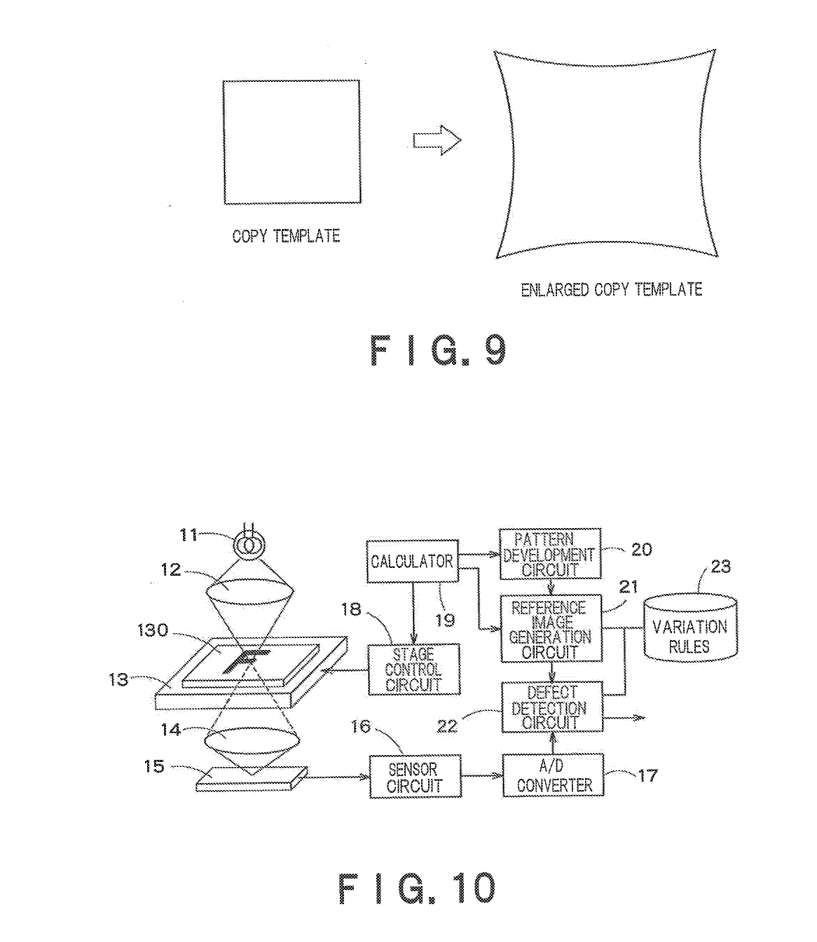

The amount of variation along with the processing of enlarging the copy template 120 may be non-uniform according to the first embodiment. For example, as illustrated in FIG. 9, when a rectangular template is stretched, the amount of variation at the four corners is larger than the amount of variation at other regions, and thus a shape distortion occurs. Thus, the reference image to be compared with the sensor image needs to be created in consideration of an impact of such a shape distortion.

FIG. 10 illustrates a schematic structure of a checking device according to the present embodiment. The present embodiment is different from the first embodiment illustrated in FIG. 7 in that a storage unit 23 for storing variation rules and coordinate conversion rules therein is provided. In FIG. 10, like reference numerals are denoted to like parts identical to those in the first embodiment illustrated in FIG. 7.

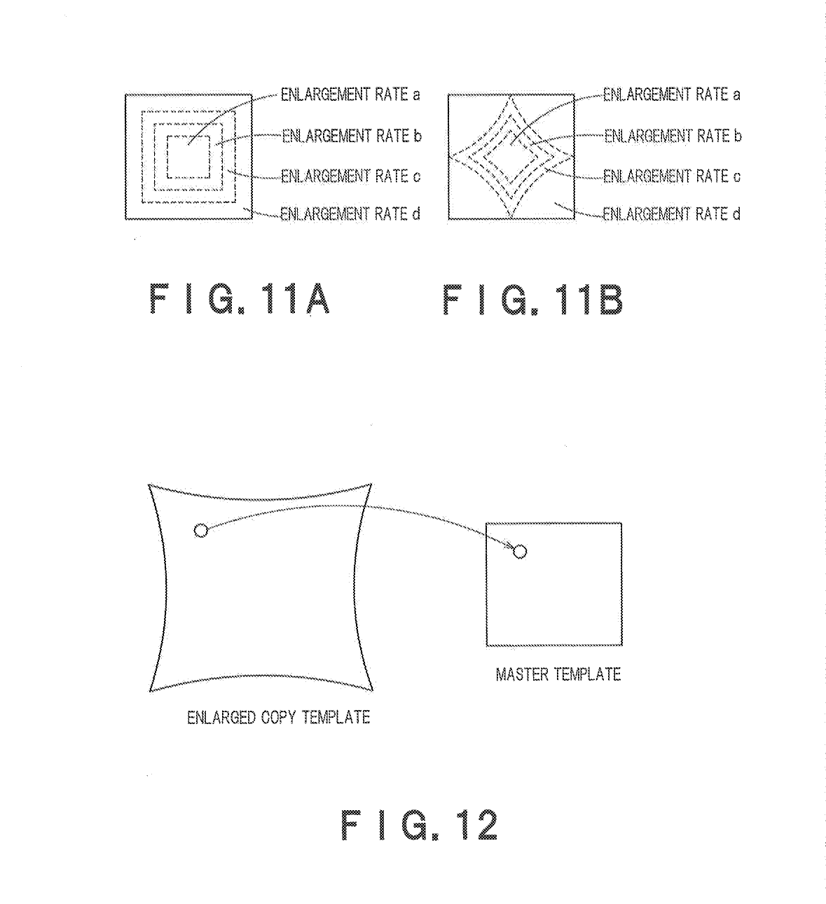

For example, as illustrated in FIG. 11A or FIG. 11B, the variation rules define an enlargement rate per region depending on a shape distortion due to the enlargement of the template. For example, an enlargement rate of the periphery of the template is defined to be larger than an enlargement rate of the center of the template.

The variation rule is different depending on a template enlarging processing. For example, the variation rule as illustrated in FIG. 11A is used when the template is enlarged due to expansion. Further, for example, the variation rule illustrated in FIG. 11B is used when the template is enlarged due to stretch in the XY direction.

The reference image generation circuit 21 uses such a variation rule to correct the pattern data in the reference image. Thereby, the reference image including the pattern data suitable for comparison with the sensor image shooting the enlarged copy template 130 with a shape distortion can be generated.

The coordinate conversion rule is used for calculating a defect coordinate on the master template 100 from a defect coordinate of the enlarged copy template 130 with a shape distortion. The position correction using the coordinate conversion rule corresponds to reverse conversion of the position correction using a variation rule. The defect detection circuit 22 detects a mismatched portion between the sensor image and the reference image as a defect, and calculates a predictive defect coordinate on the master template 100 from the defect coordinate and the coordinate conversion rule.

The reference image is generated by use of a variation rule in this way so that even when a shape distortion occurs along with the processing of enlarging the copy template 120, a defect on the enlarged copy template 130 can be accurately detected. The coordinate conversion rule is used thereby to accurately find the position of the defect on the master template 100.

In the second embodiment, the variation rules preferably consider a density of the pattern provided on the template and a type of pattern (line pattern, hole pattern or the like). For example, the enlargement rate is adjusted depending on a magnitude of the pattern density. The variation rule may be described as a function.

The variation rules may be previously created by simulation or may be created from the shape of the enlarged copy template 130 produced.

The copy template in which the concavo-convex pattern of the master template is copied is enlarged and the enlarged copy template is checked in the embodiment, but the copy template may have a pattern corresponding to the concavo-convex pattern of the master template, not a concavo-convex pattern corresponding to the concavo-convex pattern of the master template.

For example, resin which changes in its color due to light irradiation and contains a stretch component is prepared as a material of the copy template. The surface (concavo-convex pattern surface) of the master template is arranged near the resin surface, and a light is irradiated thereon via a polarizer from the back surface (surface on which the concavo-convex pattern is not formed) of the master template. Thereby, a near-field light occurs at the convex parts of the master template. The near-field light is used to change the color of the resin, thereby obtaining a patterned copy template, The pattern corresponds to the concavo-convex pattern of the master template. Thereafter, the copy template is stretched and the enlarged pattern is checked. A presence of a defect on the master template and the position of the defect can be detected also with the method,

While certain embodiments have been described, these embodiments have been presented by way of example only, and are not intended to limit the scope of the inventions, Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A lithography original checking method comprising:
applying resin onto a first lithography original having a first concavo-convex pattern;
hardening the resin;
releasing the hardened resin from the first lithography original and producing a second lithography original having a second concavo-convex pattern corresponding to the first concavo-convex pattern;
enlarging the second lithography original;
detecting a defect on the enlarged second lithography original; and
calculating a position of a defect on the first lithography original based on the position of the detected defect.

2. The lithography original checking method according to claim 1,
wherein the first concavo-convex pattern contains first alignment marks,
the second concavo-convex pattern contains second alignment marks corresponding to the first alignment marks,
an enlargement rate of the second lithography original is found based on the coordinates of the first alignment marks and the coordinates of the second alignment marks on the second lithography original, and
the enlargement rate is used to calculate the positions of defects on the first lithography original.

3. The lithography original checking method according to claim 2, wherein the first alignment marks are arranged at the four corners of the first lithography original.

4. The lithography original checking method according to claim 1, wherein an image obtained by shooting the enlarged second lithography original is compared with a reference image generated from design data of the first lithography original thereby to detect a mismatched portion as a defect.

5. The lithography original checking method according to claim 4, wherein the reference image is corrected based on a shape change due to the enlargement of the second lithography original.

6. The lithography original checking method according to claim 5, wherein the reference image is corrected based on a pattern density or a pattern type of the first concavo-convex pattern.

7. A lithography original checking device comprising:
an imaging unit which has a light source, a condensing lens and an objective lens, and shoots a second lithography original placed on a stage, the second lithography original including a second concavo-convex pattern corresponding to a first concavo-convex pattern of a first lithography original; and
a detection unit configured to compare a reference image generated from design data of the first lithography original and a shot image generated by the imaging unit, thereby to detect a mismatched portion as a defect,
wherein the second concavo-convex pattern corresponds to the enlarged first concavo-convex pattern.

8. The lithography original checking device according to claim 7, further comprising:
a generation unit for generating the reference image,
wherein the generation unit corrects the reference image based on a shape change due to the enlargement of the second lithography original.

9. The lithography original checking device according to claim 8, wherein the generation unit corrects the reference image based on a pattern density or a pattern type of the first concavo-convex pattern.

10. The lithography original checking device according to claim 8, further comprising a storage unit for storing variation rules defining the shape change.

11. The lithography original checking device according to claim 7, wherein the detection unit calculates the positions of defects on the first lithography original based on the positions of the detected defects and the enlargement rate of the second lithography original.

12. A pattern data creating method comprising:
creating pattern data from design data of a first lithography original; and
correcting the pattern data based on a shape change due to a processing of enlarging a second lithography original formed by transferring a concavo-convex pattern of the first lithography original.

13. The pattern data creating method according to claim 12, wherein the shape change indicates a different enlargement rate per region.

14. The pattern data creating method according to claim 13, wherein the shape change is different depending on a pattern density or a pattern type of the concavo-convex pattern.
